(19) United States
(12) Patent Application Publication
(10) Pub. No.: US 2026/0020108 A1
(43) Pub. Date: Jan. 15, 2026

(54) PEER IN HYBRID PEER-TO-PEER NETWORK AND CLIENT OPERATING METHOD

(71) Applicant: Electronics and Telecommunications Research Institute, Daejeon (KR)

(72) Inventor: Wook HYUN, Daejeon (KR)

(73) Assignee: Electronics and Telecommunications Research Institute, Daejeon (KR)

(21) Appl. No.: 19/265,214

(22) Filed: Jul. 10, 2025

(30) Foreign Application Priority Data
Jul. 12, 2024 (KR) 10-2024-0092569
May 20, 2025 (KR) 10-2025-0065515

(51) Int. Cl. H04W 76/40; H04W 28/02

(52) U.S. Cl. CPC H04W 76/40; H04W 28/0268

(57) ABSTRACT

A method of operation of peers and clients in a hybrid peer-to-peer network is disclosed. The method of operation of the disclosed requesting client includes an operation of transmitting a broadcast data message to a neighboring peer in an overlay network to which the requesting client belongs, and an operation of receiving a response data message corresponding to the broadcast data message from a responding client via a transport method other than the overlay network. The response data message is generated by the responding client in response to the broadcast data message transmitted via the neighboring peer.

### CROSS-REFERENCE TO RELATED APPLICATIONS

This application claims the benefit of earlier filing date and right of priority to Korean Application No. 10-2024-0092569, filed on Jul. 12, 2024, Korean Application No. 10-2025-0065515, filed on May 20, 2025, the contents of which are all hereby incorporated by reference herein in their entirety.

### TECHNICAL FIELD

The following description describes how peers and clients operate within a hybrid peer-to-peer network.

### BACKGROUND

An overlay network is another network built on top of an existing network, and is a virtual network that is built by configuring separate nodes and logical links on top of the existing network. This overlay network can provide more efficient network services by increasing scalability by utilizing the existing network. Depending on the implementation method, an overlay network can be divided into a mesh-based overlay network and a tree-based overlay network.

Mesh-based overlay networks can quickly transmit and receive large files in a non-real-time manner, but may not be suitable for real-time data transmission. In other words, mesh-based overlay networks can increase stability and scalability, but may not be suitable for real-time live services.

In a tree-based overlay network, a method can be used in which one or a few source terminals transmit data in a relay form to a number of receiving terminals. A tree-based overlay network can transmit real-time data quickly, but it is difficult to configure and maintain the tree, and if a peer in the middle of the tree leaves or fails, data may not be transmitted to a number of peers connected to that peer.

To overcome these shortcomings, hybrid overlay networks that combine tree-based overlay networks and mesh-based overlay networks are being studied.

### SUMMARY

According to the present disclosure, a request transmitted on an HP2P network is transmitted to all peers through the HP2P network, but a response is transmitted through a communication method other than the HP2P network, or transmitted through the shortest path even through the HP2P network, thereby effectively preventing unnecessary data from being transmitted to and from the HP2P network, and effectively protecting privacy, copyright, and intellectual property rights of the response.

However, technical challenges are not limited to the technical challenges described above, and other technical challenges may exist.

A method of operation of a requesting client according to one embodiment of the present disclosure may include transmitting a broadcast data message to a neighboring peer within an overlay network to which the requesting client belongs; and receiving a response data message corresponding to the broadcast data message from a responding client via a transmission method other than the overlay network, and the response data message may be generated by the responding client in response to the broadcast data message transmitted through the neighboring peer.

The broadcast data message may include at least one of a response-routing type for the broadcast data message, a message type, a message ID, a network address to receive the response data message, a criterion for determining the responding client, a request data payload, and whether encryption is required for the response data message.

The operation method of the requesting client may further include determining whether an ID of the response data message corresponds to an ID of the broadcast data message; and verifying a content of the response data message in response to the ID of the response data message corresponding to the ID of the broadcast data message.

The response client may be configured to determine whether to generate a response data message based on at least one request parameter included in the broadcast data message.

The response data message may include at least one of a response-routing type, a message type, a message ID, and a response data payload for the response data message.

The neighboring peer may be configured to forward the broadcast data message received from the requesting client to a peer connected through the overlay network.

The overlay network may be a network with a tree structure.

The transmission method may be a method that is transmitted unicast between the requesting client and the responding client.

A method of operation of a request client according to one embodiment of the present disclosure may include transmitting a broadcast data message to a neighboring peer within an overlay network to which the requesting client belongs; and receiving a response data message corresponding to the broadcast data message from the neighboring peer, and the response data message may be generated by a responding client receiving the broadcast data message transmitted through the neighboring peer.

The broadcast data message may include at least one of a response-routing type for the broadcast data message, a message type, a message ID, a network address to receive the response data message, a criterion for determining the responding client, a request data payload, and whether encryption is required for the response data message.

The neighboring peer may be configured to: append its own unique identifier to the received broadcast data message; and forward the broadcast data message with the its own unique identifier appended to a peer connected through the overlay network.

The neighboring peer may be configured to: check whether its own unique identifier is at a top of a list included in the received response data message; based on the its own unique identifier being at the top of the list, delete the its own unique identifier from the list, and based on an identifier of a next peer included in the list, transmit the response data message with its own unique identifier deleted to the next peer.

The response client may be configured to determine whether to generate a response data message based on at least one request parameter included in the broadcast data message.

The response data message may include at least one of a response-routing type, a message type, a message ID, and a response data payload for the response data message.

According to one embodiment of the present disclosure, a Peer of performing an operation of a requesting client may include a processor; and a memory storing at least one instruction, and the at least one instruction, when executed by the processor, cause the peer to: transmit a broadcast data message to a neighboring peer within an overlay network to which the requesting client belongs, and receive a response data message corresponding to the broadcast data message from a responding client via a transmission method other than the overlay network, and the responding client may generate the response data message in response to the broadcast data message transmitted through the neighboring peer.

The broadcast data message may include at least one of a response-routing type for the broadcast data message, a message type, a message ID, a network address to receive the response data message, a criterion for determining the responding client, a request data payload, and whether encryption is required for the response data message.

The at least one instruction, when executed by the processor, cause the peer to: determine whether an ID of the response data message corresponds to an ID of the broadcast data message, and verify a content of the response data message in response to the ID of the response data message corresponding to the ID of the broadcast data message.

The response client may be configured to determine whether to generate a response data message based on at least one request parameter included in the broadcast data message.

The response data message may include at least one of a response-routing type, a message type, a message ID, and a response data payload for the response data message.

According to one embodiment, a response on a network can be transmitted through a different transmission method from that of the request, or transmitted through the shortest path even if it uses the same transmission method as that of the request, thereby effectively preventing unnecessary traffic generation.

According to one embodiment, the inherent limitations of distributed peer-to-peer architectures can be effectively overcome by defining the mechanisms and extensions of the protocol required to implement efficient request-response services in a P2P environment through an asymmetric response routing scheme. This scheme can optimize network performance and efficiently reduce unnecessary traffic distribution between peers.

According to one embodiment, the response can continue its journey back to the originally requesting peer by forwarding the response to the next peer corresponding to the topmost peer in the remaining list of the via field after the intermediate peer removes its own identifier from the via field according to the reverse response routing scheme. Unlike the request, instead of the intermediate peer broadcasting the response to other peers, the peers can forward the response in the reverse order of the original request path, strictly following the path set in the via field. Such targeted forwarding can minimize unnecessary network traffic and ensure that the response reaches only the intended recipients.

### BRIEF DESCRIPTION OF THE DRAWINGS

FIG. 1 is a diagram for explaining a network structure according to one embodiment.

FIG. 2 and FIG. 3 are diagrams for explaining asymmetric response routing according to one embodiment.

FIG. 4 and FIG. 5 are diagrams for explaining reverse response routing according to one embodiment.

FIG. 6 and FIG. 7 are diagrams for explaining a method of operation of a request client according to one embodiment.

FIG. 8 is a diagram for explaining a peer according to one embodiment.

### DETAILED DESCRIPTION

Specific structural or functional descriptions of the embodiments are disclosed for illustrative purposes only and may be implemented in various forms. Therefore, the actual implemented form is not limited to the specific embodiments disclosed, and the scope of the present disclosure includes modifications, equivalents, or alternatives included in the technical idea described in the embodiments.

In this document, the phrases “A or B”, “at least one of A and B”, “at least one of A or B”, “A, B, or C”, “at least one of A, B, and C”, “at least one of A, B, or C”, and “a combination of one or more of A, B, and C” can each include any one of the items listed together in that phrase, or all possible combinations thereof. Although the terms first or second, etc. may be used to describe various components, such terms should be construed only to distinguish one component from another. For example, a first component may be referred to as a second component, and similarly, a second component may also be referred to as a first component.

When it is said that a component is “connected” to another component, it should be understood that it may be directly connected or connected to that other component, but there may also be other components present in between.

Singular expressions include plural expressions unless the context clearly indicates otherwise. In this specification, the terms “comprises” or “have” should be understood to specify the presence of a described feature, number, step, operation, component, part, or combination thereof, but do not exclude the possibility of the presence or addition of one or more other features, numbers, steps, operations, components, parts, or combinations thereof.

Unless otherwise defined, all terms used herein, including technical or scientific terms, have the same meaning as commonly understood by one of ordinary skill in the art. Terms defined in commonly used dictionaries should be interpreted as having a meaning consistent with the meaning they have in the context of the relevant art, and will not be interpreted in an idealized or overly formal sense unless explicitly defined herein.

Hereinafter, embodiments will be described in detail with reference to the attached drawings. When describing with reference to the attached drawings, identical components are given the same reference numerals regardless of the drawing numbers, and redundant descriptions thereof will be omitted.

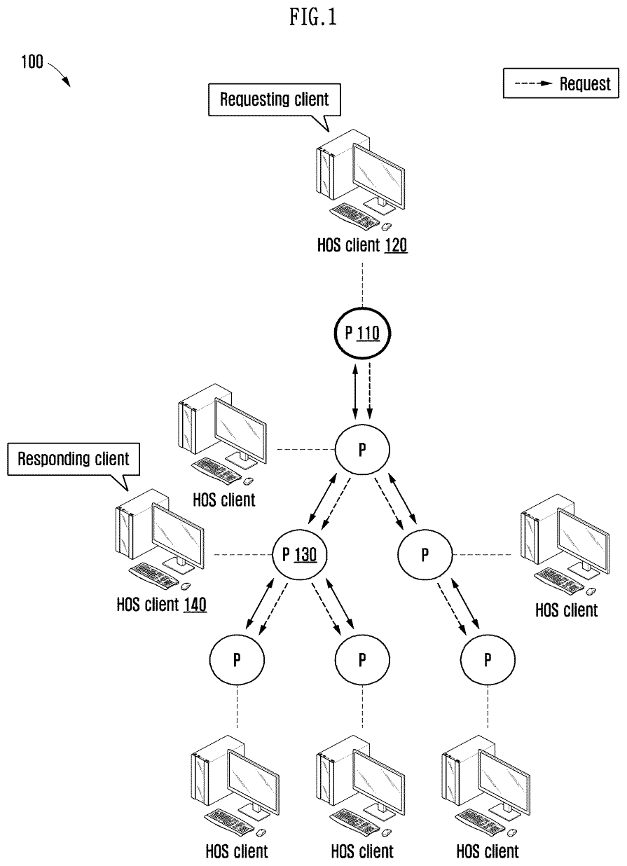

FIG. 1 is a diagram for explaining a network structure according to one embodiment.

Referring to FIG. 1, a network (100) in which multiple peers are connected is illustrated as an example. Multiple peers may be connected to each other through a hybrid overlay network. In FIG. 1, multiple peers are illustrated as being connected in a tree structure for convenience of explanation, but the invention is not limited to the above-described example and other structures (e.g., mesh structures, etc.) may also be applied without limitation.

A HOS client (hybrid overlay service client) operates on a peer and may represent a client of a service owner who wants to create a service or a service user who wants to receive a service through a hybrid overlay network. In other words, a service owner or a service user may create or access a hybrid overlay network through the HOS client. In this specification, for convenience of explanation, a service holder may be referred to as a service owner. In addition, a hybrid overlay service provided through a hybrid overlay network in this specification may also be referred to as a service for convenience of explanation. In addition, in this specification, an HOS client may be referred to as a client or a service client.

A peer may represent a communication device or communication node connected on a network (100), and the HOS client described above may be implemented and operated on the peer. A peer may also be referred to as a hybrid peer that can exchange data using mesh-based and tree-based methods running on a hybrid overlay network.

Peer-to-peer may refer to the way in which nodes of a system share resources to provide services supported by the system. Nodes of the system may provide services to other nodes or request services from other nodes. The peers described above may correspond to nodes of a P2P system.

A hybrid overlay network may represent a peer-to-peer overlay network in which participating peers exchange data in a pull and push method. In other words, the hybrid overlay network may organize and maintain a tree-style path that can push data to all peers without loops and simultaneously fetch data from other peers. The hybrid overlay network may include a distributed overlay network. In this specification, for convenience of explanation, the hybrid overlay network may be referred to as an overlay network or an overlay.

A hybrid overlay network may be a network that combines a tree-based overlay network with a mesh-based overlay network. Various services may be provided in a hybrid overlay network. It may be important to know which service the data transmitted through the hybrid overlay network corresponds to and how the detailed data transmission configured to provide each service is configured. In addition, control over users who can access the service and users who have data transmission right may also be important.

HOS (hybrid overlay service) may be based on a HP2P (hybrid peer to peer) network. The HP2P network may distribute real-time data to multiple peers and provide a distributed service network required for video conferencing, blockchain, broadcasting, games, etc.

A first HOS client (120) corresponding to a first peer (110) included in a network (100) may transmit a request to another client included in the network (100). The request may be propagated within the network (100) through neighboring (or adjacent) peers as illustrated in FIG. 1. When the request is transmitted to a second peer (130) that will generate a response, a second HOS client (140) corresponding to the second peer (130) may generate a response to the received request and transmit it to the first HOS client (120).

A P2P network has the characteristic that all data is shared among all nodes belonging to the network, and due to this characteristic, when implementing a request-response service based on a P2P network, a lot of unnecessary traffic may be transmitted to other peers. In order to reduce unnecessary traffic, requests that need to be transmitted to everyone can be transmitted through the HP2P network, only some can be selectively responded to, and responses that do not need to be shared with everyone can be transmitted through another path (e.g., unicast, etc.). In this way, the response can be transmitted through a different transmission method from the request, or even if it uses the same transmission method as the request, it can be transmitted through the shortest path, thereby effectively preventing the generation of unnecessary traffic.

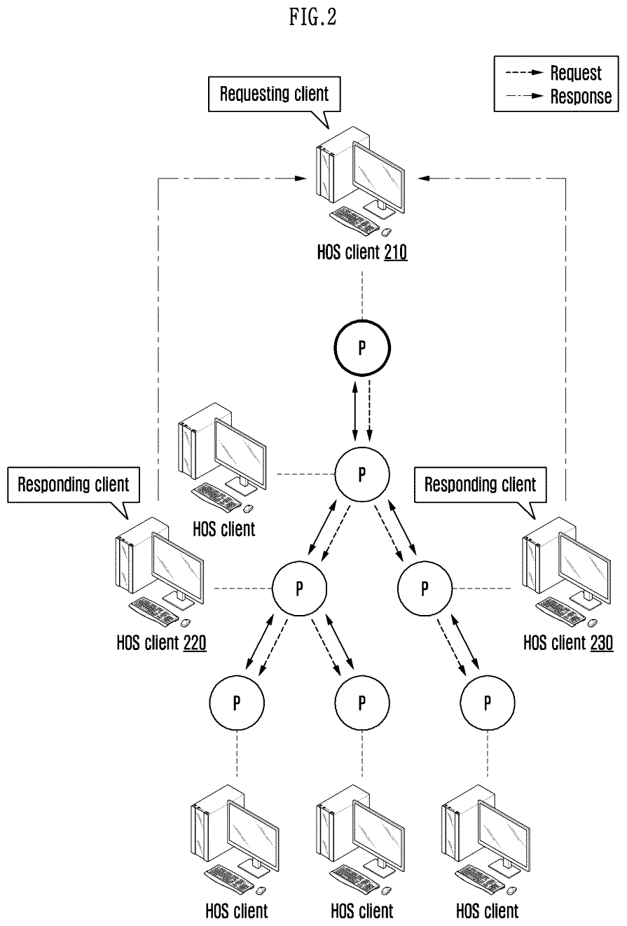

The method in which a response generated from a second HOS client (140) is transmitted to a first HOS client (120) is described in detail with reference to FIGS. 2 to 4. In this specification, for convenience of explanation, the first HOS client (120) that generates a request may be referred to as a requesting client, and the second HOS client (140) that generates a response may be referred to as a responding client.

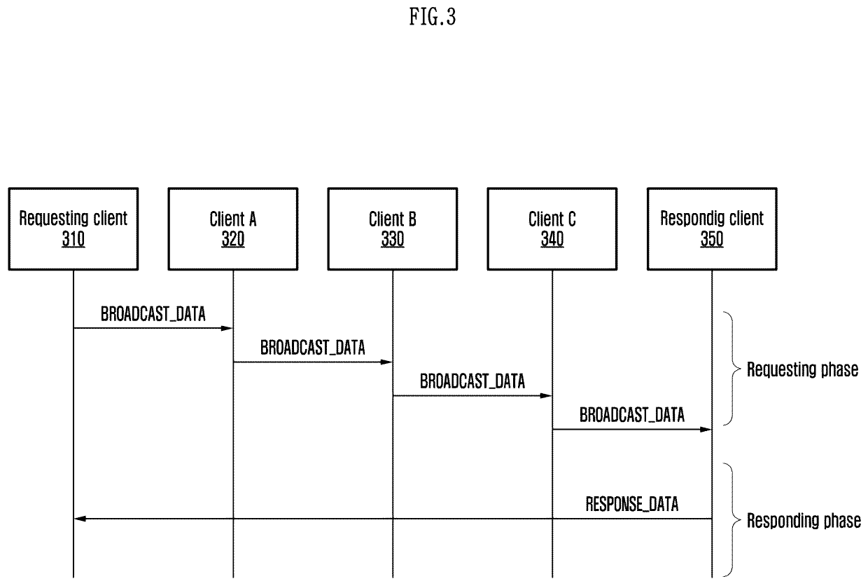

FIG. 2 and FIG. 3 are diagrams for explaining asymmetric response routing according to one embodiment.

Referring to FIG. 2, an example of asymmetric response routing being performed between a requesting client (210) and responding clients (220, 230) is illustrated.

A requesting client (210) may request a HOS agent to transmit a request based on a BROADCAST_DATA message specified in ITU-T Q.4102. The requesting client (210) may provide the following parameters to the HOS agent, and the HOS agent may embed the provided parameters in an extended header of the BROADCAST_DATA message.

extension: set to “response-routing; asymmetric”

ext-rr-message-type: set to “ext-rr-request”

ext-rr-message-type: set to “ext-rr-request”

ext-rr-message-id: a unique identifier for request-response correlation

ext-rr-respond-to: specifies the network address for the response. For example, the network address of the destination of the response. This network address must be externally accessible, and responsibility for such external access is given to the application of the peer. Listening to this network address is not the responsibility of the peer, but is the responsibility of the application or a third-party server.

ext-rr-respond-by: criteria determining which nodes are eligible to respond. For example, as a field that specifies which peer among the peers participating in the HP2P network will send the response, it may include the following parameters:
Target-peers: it includes peer IDs and has an array format;
Any-peer: Peers that are able to respond to the request may do so, but are not obligated to do so; and
Every-peer: Any peer that receives the request is targeted, which can be used to determine the status of peers included in an HP2P network, for example.

ext-rr-request: the request data payload. For example, data that needs to be passed to applications connected to other peers, such as requirements, requests, and queries, which may be data defined with a separate syntax, or natural language prompts for LLM use.

ext-rr-secure-response: indicates whether response encryption is required. For example, in cases where security is required, the requesting peer may require encryption of the response, and the responding peer may send the response encrypted with the requesting peer's public key. To this end, the requesting peer's public key may be included as a subparameter of secure-response.

Requests based on BROADCAST_DATA messages may be forwarded through neighboring (or adjacent) peers in the network. Intermediate peers may forward BROADCAST_DATA messages to all connected peers as specified in ITU-T Q.4102.

Upon receiving a request based on a BROADCAST_DATA message, a peer may forward the message to the connected HOS client. Upon receiving the forwarded message, the HOS client may evaluate whether a response is required based on the request parameters in the payload of the BROADCAST_DATA message. For example, the syntax of the request may vary depending on the service.

If a particular HOS client (e.g., responding clients (220, 230)) decides to respond to that message, it may send a response to the network address specified in the ‘respond-to’ field of that request, and the response may include:

extension: set to “response-routing: asymmetric”

ext-rr-message-type: set to “ext-rr-response”

ext-rr-message-id: identical to the unique identifier in the corresponding request. For example, since requests and responses are transmitted via different transports, message-id is used for request-response mapping.

ext-rr-response: the response data payload. For example, it can be data defined with a separate syntax or a natural language prompt for LLM use, as response data to requirements, requests, and inquiries. For example, if the secure-response value of the request is ‘true’, the response is signed and transmitted with your own private key.

ext-rr-signature: an optional cryptographic signature for response integrity verification

The response generated from the response clients (220, 230) may be transmitted to the request client (210) via a transmission method other than the overlay network through which the request was transmitted. For example, the other transmission method may be a method in which the request client (210) and the response clients (220, 230) are unicast-transmitted, but is not limited to the above-described example and may include various transmission methods. In this way, since the method through which the request and the response are transmitted is not the same, the path through which the request and the response are transmitted may be referred to as an asymmetric routing path.

Upon receiving a response through the asymmetric routing path, the requesting client (210) may initiate the following verification process.

The requesting client (210) may verify the message ID of the received response to determine whether the message ID of the received response matches the message ID of the previously transmitted request. If the message ID of the received response matches the message ID of the request, the requesting client (210) may process and verify the content of the response. If additional security measures are implemented, the requesting client (210) may also verify the integrity and authenticity of the response using the provided cryptographic signature. This verification process may ensure proper correlation between the request and the response, thereby maintaining the integrity of the asymmetric communication protocol.

By defining the mechanism and extension of the protocol required to implement efficient request-response services in a P2P environment through the asymmetric response routing method described above, the limitations inherent in distributed peer-to-peer architectures may be effectively overcome. This method can optimize network performance and efficiently reduce unnecessary traffic distribution between peers.

According to an embodiment, the network (100) structure illustrated in FIG. 1 may be utilized to transmit a one-time request periodically or aperiodically. For example, the network (100) may be utilized to periodically determine the status of equipment in which a peer is driven, such as SNMP (simple network management protocol). Alternatively, the network (100) may be utilized to transmit a request by a user at any time aperiodically, such as sending a request to a network configured with an LLM (large language model) model and obtaining a response thereto. In addition, the network (100) may be utilized when security of response data is required.

Referring to FIG. 3, a flowchart for explaining the communication operation of asymmetric response routing is exemplarily illustrated.

Referring to FIG. 3, an example is illustrated to explain communication between a requesting client (310) and a responding client (350). In FIG. 3, for convenience of explanation, it is assumed that the requesting client (310), client A (320), client B (330), client C (340), and responding client (350) are connected to each other in the following order on the network.

A requesting client (310) may generate a request based on a BROADCAST_DATA message and transmit it to a neighboring (or adjacent) client A (320). Client A (320) may identify the respond-by field included in the received request to determine whether a response is possible, and if it is determined that a response is not possible, may forward the request to a neighboring (or adjacent) client B (330) without generating a response. Clients B and C (330, 340) may also operate in the same manner to forward the request to a responding client (350).

The response client (350) may determine whether a response is possible by checking the respond-by field included in the received request, and if it is confirmed that a response is possible, it may generate a response corresponding to the request. The response client (350) may identify the respond-to field included in the received request and transmit the response to the network address (e.g., the request client (310)) for the response. In order to suppress unnecessary traffic generation, the response client (350) may transmit the response to the request client (310) through a different transmission method than the request.

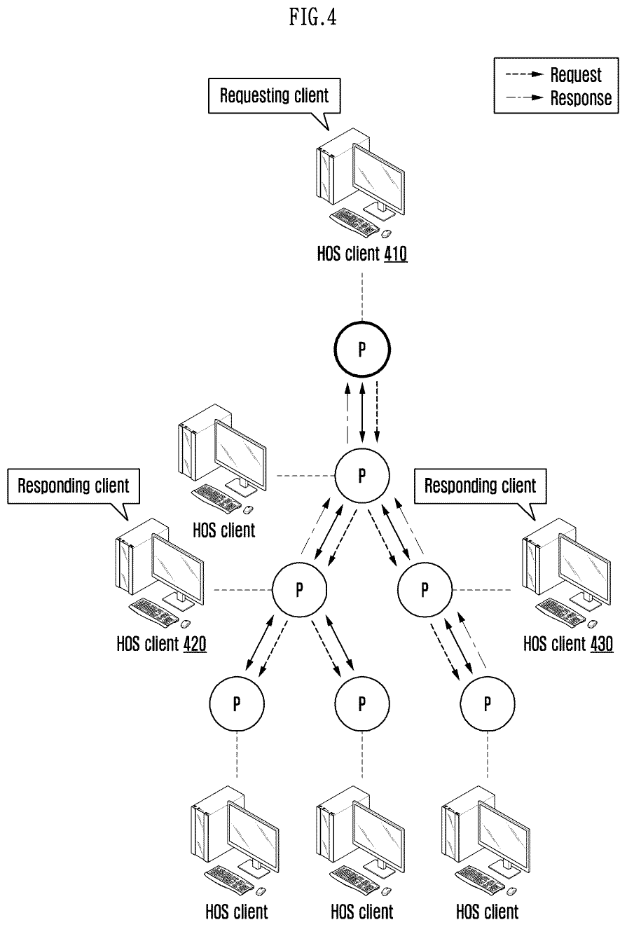

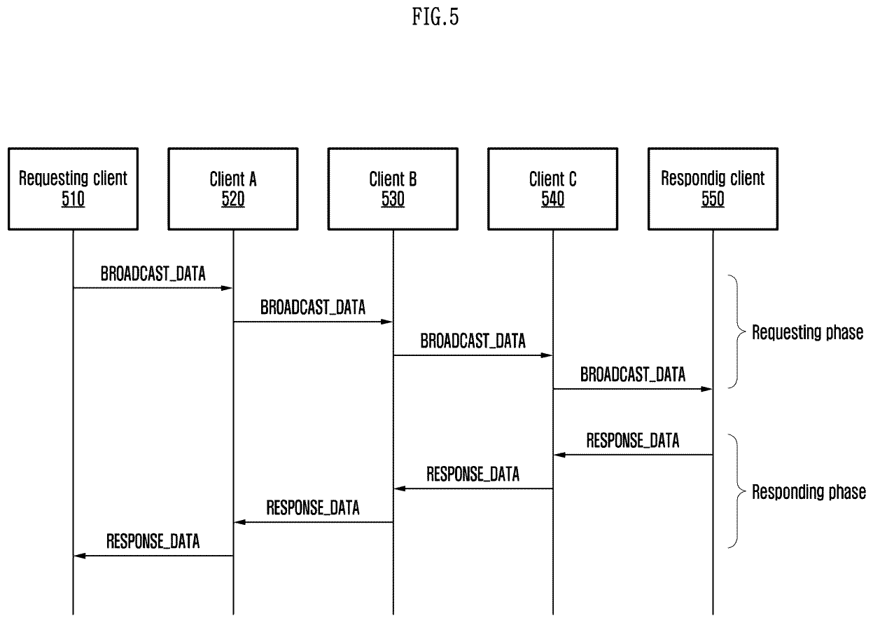

FIG. 4 and FIG. 5 are diagrams for explaining reverse response routing according to one embodiment.

Referring to FIG. 4, an example of reverse response routing being performed between a requesting client (210) and responding clients (220, 230) is illustrated.

When it is difficult for a response to be directly delivered from a responding client to a requesting client through the asymmetric response routing described in FIG. 3 due to a firewall or router environment, or in other words, when it is difficult for applications connected to peers to directly receive the response, the mechanism and extension of the protocol required to enable reception of the response message through the established hybrid overlay network can be determined. This communication method may ensure reliable message delivery even in a network configuration where asymmetric response routing may be impeded due to network security measures or topological constraints.

A requesting client (410) may request a HOS agent to transmit a request using a BROADCAST_DATA message specified in ITU-T Q.4102. The requesting client (410) may provide the following parameters to the HOS agent, and the HOS agent may embed the provided parameters in an extended header of the BROADCAST_DATA message.

extension: set to “response-routing: reversive”.

message-type: set to “ext-rr-request”.

ext-rr-message-id: a unique identifier for request-response correlation.

ext-rr-respond-by: criteria determining which nodes are eligible to respond. For example, this is a field that specifies the peers among the peers participating in the HP2P network to which a response will be sent, and may include, for example, the following parameters: Target-peers: This is an array format that describes the peer IDs; Any-peer: Peers that can respond to the request can respond, but are not obligated to respond to the request; Every-peer: All peers that receive the request are the target, and can be used, for example, to determine the status of peers included in the HP2P network.

ext-rr-request: the request data payload. For example, data that needs to be passed to applications connected to other peers, such as requirements, requests, and queries, which may be data defined with a separate syntax, or natural language prompts for LLM use.

ext-rr-secure-response: indicates whether response encryption is required. For example, in cases where security is required, the requesting peer may require encryption of the response, and the responding peer may send the response encrypted with the requesting peer's public key. To this end, the requesting peer's public key may be included as a subparameter of secure-response.

ext-rr-via: peer-id of the peer of the requesting client.

Requests based on BROADCAST_DATA messages may be propagated through neighboring (or adjacent) peers in the network. Intermediate peers may forward BROADCAST_DATA messages to all connected peers as specified in ITU-T Q.4102.

An intermediate peer in an HP2P network can facilitate a reverse response routing mechanism. The intermediate peer may ensure efficient and accurate message transmission through the HP2P network by performing the following actions when processing a request or response.

When processing a request, the intermediate peer may perform the following sequence of actions: The intermediate peer may append its own unique identifier to the via parameter of the request message. This action creates a trail of the intermediate peer through which the request passed, enabling the response to traverse the same path in reverse. The peer may then broadcast the modified request (i.e., a request with its own unique identifier appended to the top of the via parameter) to all other peers directly connected to it within the HP2P network. This broadcast may propagate the request broadly throughout the network, maximizing the likelihood that it will reach the intended responding peer or peers. Concurrently, the intermediate peer may forward the request to all connected applications. This action allows the local application of the intermediate peer to evaluate the request and potentially generate a response if it meets the criteria specified in the respond-by field in the request.

Upon receiving a request based on a BROADCAST_DATA message, the peer may forward the message to the connected HOS client. Upon receiving the forwarded message, the HOS client may evaluate whether a response is required based on the request parameters in the message content. For example, the syntax of the request may vary depending on the service.

If a particular HOS client (e.g., responding clients (420, 430)) decides to respond to that message, it may send a response to the topmost peer in the via parameter of that request. The response may include:

extension: set to “response-routing: reversive”.

message-type: set to “ext-rr-response”.

ext-rr-message-id: identical to the unique identifier in the corresponding request.

ext-rr-response: the response data payload. For example, it can be data defined with a separate syntax or a natural language prompt for LLM use, as response data to requirements, requests, and inquiries. For example, if the secure-response value of the request is ‘true’, the response is signed and transmitted with your own private key.

ext-rr-signature: an optional cryptographic signature for response integrity verification.

By having the responding clients (420, 430) send the response to the top peer in the via parameter of the request, the response may be delivered in the opposite direction to the requesting client (410) along the path along which the request was delivered.

When handling a response, an intermediate peer may follow the following sequence of procedures: The intermediate peer may examine the via field of the response message, checking if its identifier is at the top of the list This check may be to determine whether the current peer is the next peer to process the response. If the peer's identifier is at the top of the via field, the intermediate peer may remove it from the list. This action effectively removes the intermediate peer from the response path. After removing its identifier, the intermediate peer may forward the response to the next peer that is at the top of the remaining list contained in the via field. This forwarding ensures the response to continue returning to the original requesting peer. Importantly, unlike the request, the intermediate peer does not broadcast the response to other peers. Instead, the intermediate peer may forward the response in reverse order along the original request path, strictly adhering to the path specified in the via field. This targeted forwarding minimizes unnecessary network traffic and ensures that the response reaches only the intended recipients.

By following these procedures, the intermediate peer may contribute to the efficient and stable operation of the reverse response routing mechanism in the HP2P network, thereby facilitating accurate message delivery even in a complex network environment.

Referring to FIG. 5, a flow chart for explaining the communication operation of reverse response routing is illustrated as an example.

Referring to FIG. 5, an example is illustrated to explain communication between a requesting client (510) and a responding client (550). In FIG. 5, for convenience of explanation, it is assumed that the requesting client (510), client A (520), client B (530), client C (540), and responding client (550) are connected to each other in the following order on the network.

A requesting client (510) may generate a request based on a BROADCAST_DATA message and transmit it to a neighboring (or adjacent) client A (520). Client A (520) may check the respond-by field included in the received request to determine whether a response is possible, and if it is determined that a response is not possible, may forward the request to a neighboring (or adjacent) client B (530) without generating a response. At this time, client A (520) may forward the request with its own unique identifier added to the top of the via field to client B (530). Clients B and C (530, 340) may also operate in the same manner to forward the request to the responding client (550).

The response client (550) may check the respond-by field included in the received request to determine whether a response is possible, and if it is determined that a response is possible, can generate a response corresponding to the request. The response client (550) may check the via field included in the received request and transmit the response to the top-level peer of the via field. Unlike a request that is broadcast to all neighboring (or adjacent) peers, the response is transmitted only to the top-level peer of the via field, thereby effectively suppressing unnecessary network traffic.

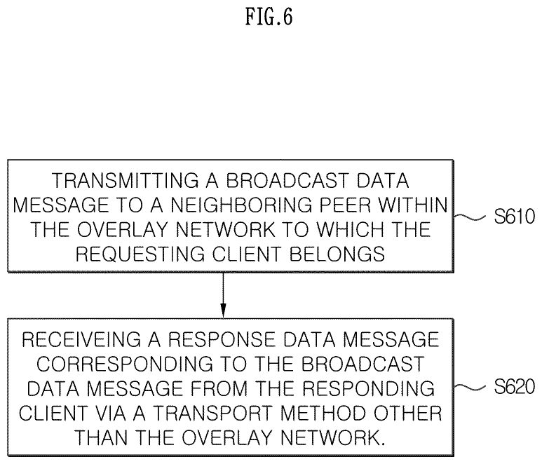

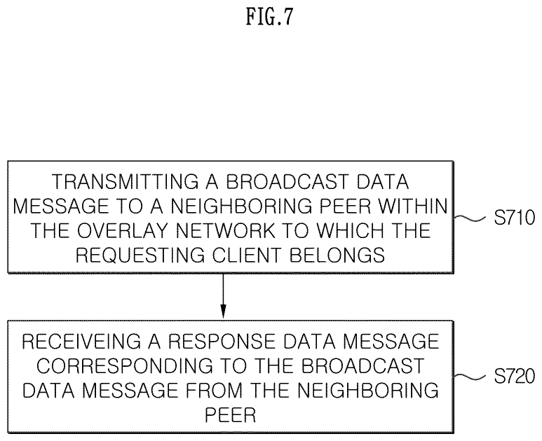

FIG. 6 and FIG. 7 are diagrams illustrating an operation method of a request client according to one embodiment.

Referring to FIG. 6, a method of operation of a requesting client according to asymmetric response routing is illustrated.

In operation (610), the requesting client transmits a broadcast data message to a neighboring peer (or adjacent peer) within the overlay network to which the requesting client belongs. The broadcast data message may include at least one of a response-routing type, a message type, a message ID, a network address to receive the response data message, a criterion for determining the responding client, a request data payload, and whether encryption is required for the response data message. The neighboring peer (or adjacent peer) may forward the broadcast data message received from the requesting client to a peer connected to it through the overlay network.

The responding client generates a response data message in response to the broadcast data message delivered through the neighbor peer. The responding client may determine whether to generate the response data message based on the request parameters included in the broadcast data message. The response data message may include at least one of a response-routing type, a message type, a message ID, and a response data payload for the response data message.

In operation (620), the requesting client receives a response data message corresponding to the broadcast data message from the responding client via a transport method other than the overlay network.

The requesting client may determine whether the ID of the response data message corresponds to the ID of the broadcast data message, and respond if the ID of the response data message corresponds to the ID of the broadcast data message, thereby verifying the content of the response data message.

The overlay network may be a network having a tree structure.

Another transmission method may be unicast transmission between the requesting client and the responding client.

Since the matters described above through FIGS. 1 to 5 are applied to each operation illustrated in FIG. 6, a more detailed description is omitted.

Referring to FIG. 7, a method of operation of a requesting client according to reverse response routing is illustrated.

In operation (710), the requesting client transmits a broadcast data message to a neighboring peer within the overlay network to which the requesting client belongs. The broadcast data message may include at least one of a response-routing type for the broadcast data message, a message type, a message ID, a criterion for determining a responding client, a request data payload, whether encryption is required for the response data message, and a peer ID of the peer of the requesting client.

A neighboring peer may add its own unique identifier to a received broadcast data message and forward the broadcast data message with its own unique identifier added to the peer connected to it through the overlay network.

A responding client may determine whether to generate a response data message based on the request parameters included in the broadcast data message.

A response data message is generated by a responding client that receives a broadcast data message delivered via a neighboring (or adjacent) peer. The response data message may include at least one of a response-routing type, a message type, a message ID, and a response data payload for the response data message.

In operation (720), the requesting client receives a response data message corresponding to the broadcast data message from the neighboring peer.

The neighboring (or adjacent peer checks whether its own unique identifier is at the top of the list included in the received response data message, and if its own unique identifier is at the top of the list, it responds by deleting its own unique identifier from the list, and based on the identifier of the next peer included in the list, transmits a response data message with its own unique identifier deleted to the next peer.

Since the matters described above through FIGS. 1 to 5 are applied to each operation illustrated in FIG. 7, a more detailed description is omitted.

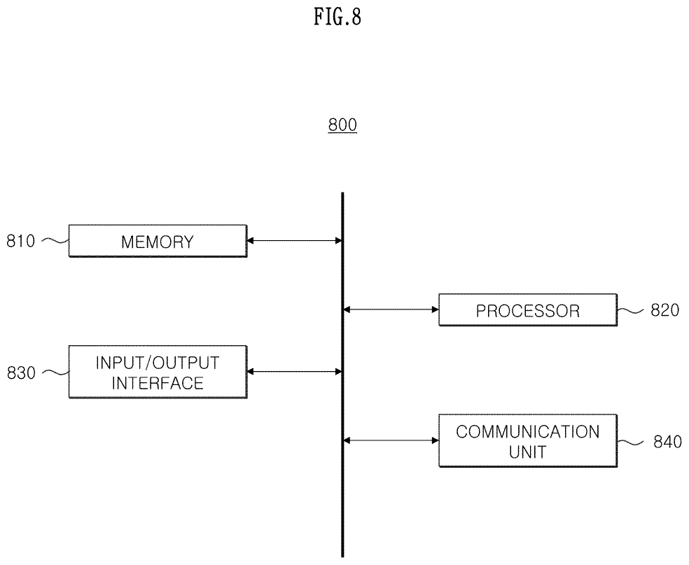

FIG. 8 is a diagram illustrating a peer according to one embodiment.

Referring to FIG. 8, the peer (800) may include a memory (810), a processor (820), an input/output interface (830), and a communication unit (840), which may communicate with each other through a communication bus. For example, the peer (800) may be a mobile device such as a mobile phone, a smart phone, a PDA, a netbook, a tablet computer, a laptop computer, etc., a wearable device such as a smart watch, a smart band, a smart glasses, etc., a computing device such as a desktop, a server, etc., a home appliance such as a television, a smart television, a refrigerator, etc., a security device such as a door lock, etc., an electronic device implemented as at least a part of a vehicle such as an autonomous vehicle, a smart vehicle, etc.

The processor (820) executes functions and instructions to be executed within the peer (800). For example, the processor (820) may process instructions stored in the memory (810). The processor (820) may perform one or more operations described through FIGS. 1 to 7. The memory (810) may include a computer-readable storage medium or a computer-readable storage device. The memory (810) may store instructions to be executed by the processor (820) and may store related information while software and/or applications are executed by the peer (800).

The input/output interface (850) can receive input from a user via traditional input methods such as a keyboard and mouse, and new input methods such as touch input, voice input, and image input. For example, the input/output interface (850) can include a keyboard, a mouse, a touch screen, a microphone, or any other device that can detect input from a user and transmit the detected input to the peer (800). In addition, the input/output interface (850) can provide output from the peer (800) to the user via visual, auditory, or tactile channels. The input/output interface (850) can include, for example, a display, a touch screen, a speaker, a vibration generating device, or any other device that can provide output to the user.

The communication unit (840) can communicate with an external device (e.g., another peer) through a wired or wireless network.

Hybrid P2P networks with tree-like hierarchical structures can be designed for rapid data distribution (e.g., IoT data, live streaming, etc.) where peers relay the data they receive to other branches. However, such architectures can be inefficient for query-response applications because queries and responses are broadcast to all peers, resulting in unnecessary bandwidth and resource consumption.

Optimized query-response applications over HP2P networks may require response routing extensions, such as selective response, where only peers belonging to a specified category respond to a query, and asymmetric response transmission, where responses are sent directly to the peer that sent the query instead of being broadcast through the tree. This can reduce network overhead and resource consumption.

The response routing extension described above may enable anycasting to be implemented within a hybrid peer-to-peer network. Anycast may be a network addressing and routing methodology in which data is routed to multiple destinations, with the correct node responding to the request.

In the context of an HP2P network, anycasting over HP2P may be achieved by the following means:

Flexible Peer Selection: The ‘respond-by’ field in the request message allows the requesting peer to specify criteria for determining which nodes can respond. These criteria may be targeted at a group of peers providing a particular service or having particular characteristics, and may reflect the anycast concept of reaching the most appropriate destination.

Asymmetric Response Routing: The system may reduce latency and improve resource utilization by sending responses directly to the requesting peer via a designated ‘respond-to’ address instead of traversing the entire overlay network. This asymmetric response routing may be similar to the goal of anycast, which is to reach the nearest instance of a service.

Dynamic Peer Discovery: As peers join and leave the HP2P network, the pool of potential responders for a given request can naturally evolve. This dynamic nature allows the system to automatically adapt to changes in network topology, service availability, and peer capabilities, further enhancing anycast-like behavior.

Load Balancing: When multiple peers can respond to a request, the network may distribute the load across the peers, either through random selection or more sophisticated load balancing algorithms. Distributing requests across multiple service instances is a key benefit of anycast in traditional networks, and can be applied in the HP2P context as well.

By leveraging the features described above, HP2P networks may provide robust, efficient, and adaptable service discovery and utilization mechanisms. This anycasting capability can enhance the network's ability to provide scalable and resilient services, especially in large-scale distributed applications where service location transparency and fault tolerance are crucial.

It may be important to note that while these features share many characteristics with traditional Anycast, they are implemented at the application layer of the HP2P protocol stack rather than at the network layer, as with IP Anycast. This approach provides application developers with more flexibility and control to define and enhance Anycast-like behavior based on their application-specific requirements and constraints.

There can be two types of components to provide anycasting services over the HP2P network.

Query node: A node that can generate and broadcast queries throughout the network. It can specify category requirements and desired response criteria, and receive responses from eligible peers without broadcasting to all peers in the network.

Response node: A node that matches a specific query category and has the necessary functionality. Such a node can evaluate the received query based on resources and status, and respond only if it satisfies the criteria and can provide the requested service.

In these service scenarios, a node may mean an application of the anycasting service rather than a machine.

Service scenarios may not require a provisioning step. To support anycasting services, peers may need to support asymmetric response routing and/or reverse response routing as described above. It may also be possible to build an HP2P network using heterogeneous types of HPEER.

In an HP2P network, nodes with and without these extensions can coexist seamlessly. Only nodes that support the asymmetric and/or reverse response routing extensions can respond, while other nodes can continue to perform their usual data distribution.

If a peer does not support the response routing extension, the message may not be delivered to that peer's application.

The embodiments described above may be implemented as hardware components, software components, and/or a combination of hardware components and software components. For example, the devices, methods, and components described in the embodiments may be implemented using a general-purpose computer or a special-purpose computer, such as, for example, a processor, a controller, an arithmetic logic unit (ALU), a digital signal processor, a microcomputer, a field programmable gate array (FPGA), a programmable logic unit (PLU), a microprocessor, or any other device capable of executing instructions and responding to them. The processing device may execute an operating system (OS) and software applications running on the OS. In addition, the processing device may access, store, manipulate, process, and generate data in response to the execution of the software. For ease of understanding, the processing device is sometimes described as being used alone, but those skilled in the art will appreciate that the processing device may include multiple processing elements and/or multiple types of processing elements. For example, a processing device may include multiple processors, or a processor and a controller. Other processing configurations, such as parallel processors, are also possible.

The software may include a computer program, code, instructions, or a combination of one or more of these, which may configure a processing device to perform a desired operation or may independently or collectively command the processing device. The software and/or data may be stored on any type of machine, component, physical device, virtual equipment, computer storage medium, or device for interpretation by the processing device or for providing instructions or data to the processing device. The software may also be distributed over network-connected computer systems and stored or executed in a distributed manner. The software and data may be stored on a computer-readable recording medium.

The method according to the embodiment may be implemented in the form of a program command that can be executed through various computer means and recorded on a computer-readable medium. The computer-readable medium may store program commands, data files, data structures, etc., alone or in combination, and the program commands recorded on the medium may be those specially designed and configured for the embodiment or may be those known to and usable by those skilled in the art of computer software. Examples of the computer-readable recording medium include magnetic media such as hard disks, floppy disks, and magnetic tapes, optical media such as CD-ROMs and DVDs, magneto-optical media such as floptical disks, and hardware devices specially configured to store and execute program commands such as ROMs, RAMs, and flash memories. Examples of the program commands include not only machine language codes generated by a compiler, but also high-level language codes that can be executed by a computer using an interpreter, etc.

The hardware device described above may be configured to operate as one or more software modules to perform the operations of the embodiment, and vice versa.

Although the embodiments have been described with limited drawings as described above, those skilled in the art can apply various technical modifications and variations based on the described embodiments. For example, appropriate results can be achieved even if the described techniques are performed in a different order than the described method, and/or components of the described system, structure, device, circuit, etc. are combined or combined in a different form than the described method, or are replaced or substituted by other components or equivalents.

Therefore, other implementations, other embodiments, and equivalents to the claims are also included in the scope of the claims described below.

What is claimed is:

1. A method of operation of a requesting client, the method comprising:
transmitting a broadcast data message to a neighboring peer within an overlay network to which the requesting client belongs; and
receiving a response data message corresponding to the broadcast data message from a responding client via a transmission method other than the overlay network,
wherein the response data message is generated by the responding client in response to the broadcast data message transmitted through the neighboring peer.

2. The method of claim 1, wherein:
the broadcast data message includes at least one of a response-routing type for the broadcast data message, a message type, a message ID, a network address to receive the response data message, a criterion for determining the responding client, a request data payload, and whether encryption is required for the response data message.

3. The method of claim 1, further comprising:
determining whether an ID of the response data message corresponds to an ID of the broadcast data message; and
verifying a content of the response data message in response to the ID of the response data message corresponding to the ID of the broadcast data message.

4. The method of claim 1, wherein:
the response client is configured to determine whether to generate a response data message based on at least one request parameter included in the broadcast data message.

5. The method of claim 1, wherein:
the response data message includes at least one of a response-routing type, a message type, a message ID, and a response data payload for the response data message.

6. The method of claim 1, wherein:
the neighboring peer is configured to forward the broadcast data message received from the requesting client to a peer connected through the overlay network.

7. The method of claim 1, wherein:
the overlay network is a network with a tree structure.

8. The method of claim 1, wherein:
the transmission method is a method that is transmitted unicast between the requesting client and the responding client.

9. A method of a requesting client comprising:
transmitting a broadcast data message to a neighboring peer within an overlay network to which the requesting client belongs; and
receiving a response data message corresponding to the broadcast data message from the neighboring peer,
wherein the response data message is generated by a responding client receiving the broadcast data message transmitted through the neighboring peer.

10. The method of claim 9, wherein:
the broadcast data message includes at least one of a response-routing type for the broadcast data message, a message type, a message ID, a network address to receive the response data message, a criterion for determining the responding client, a request data payload, and whether encryption is required for the response data message.

11. The method of claim 9, wherein:
the neighboring peer is configured to:
append its own unique identifier to the received broadcast data message; and
forward the broadcast data message with the its own unique identifier appended to a peer connected through the overlay network.

12. The method of claim 9, wherein:
the neighboring peer is configured to:
check whether its own unique identifier is at a top of a list included in the received response data message;
based on the its own unique identifier being at the top of the list, delete the its own unique identifier from the list, and
based on an identifier of a next peer included in the list, transmit the response data message with its own unique identifier deleted to the next peer.

13. The method of claim 9, wherein:
the response client is configured to determine whether to generate a response data message based on a request parameter included in the broadcast data message.

14. The method of claim 9, wherein:
the response data message includes at least one of a response-routing type, a message type, a message ID, and a response data payload for the above response data message.

15. A Peer of performing an operation of a requesting client comprising:
a processor; and
a memory storing at least one instruction,
wherein the at least one instruction, when executed by the processor, cause the peer to:
transmit a broadcast data message to a neighboring peer within an overlay network to which the requesting client belongs, and
receive a response data message corresponding to the broadcast data message from a responding client via a transmission method other than the overlay network,
wherein the responding client generates the response data message in response to the broadcast data message transmitted through the neighboring peer.

16. The peer of claim 15, wherein:
the broadcast data message includes at least one of a response-routing type for the broadcast data message, a message type, a message ID, a network address to receive the response data message, a criterion for determining the responding client, a request data payload, and whether encryption is required for the response data message.

17. The peer of claim 15, wherein:
the at least one instruction, when executed by the processor, cause the peer to:
determine whether an ID of the response data message corresponds to an ID of the broadcast data message, and
verify a content of the response data message in response to the ID of the response data message corresponding to the ID of the broadcast data message.

18. The peer of claim 15, wherein:
the response client is configured to determine whether to generate a response data message based on at least one request parameter included in the broadcast data message.

19. The peer of claim 15, wherein:
the response data message includes at least one of a response-routing type, a message type, a message ID, and a response data payload for the response data message.
